(19) United States
(12) Patent Application Publication
(10) Pub. No.: US 2025/0289012 A1
(43) Pub. Date: Sep. 18, 2025

(54) POLYURETHANE INJECTION GUN ASSEMBLY

(71) Applicants: Brian Cvetezar, Manitowoc, WI (US); Jeff Cvetezar, Manitowoc, WI (US); Ernie Cvetezar, Manitowoc, WI (US)

(72) Inventors: Brian Cvetezar, Manitowoc, WI (US); Jeff Cvetezar, Manitowoc, WI (US); Ernie Cvetezar, Manitowoc, WI (US)

(21) Appl. No.: 19/079,808

(22) Filed: Mar. 14, 2025

Related U.S. Application Data
(60) Provisional application No. 63/565,361, filed on Mar. 14, 2024.

(51) Int. Cl. B05B 7/00

(52) U.S. Cl. CPC B05B 7/0018; B05B 7/0093

(57) ABSTRACT

A polyurethane injection gun assembly includes a frame, a handle coupled to the frame, a wheel coupled to the frame, and a mixing assembly coupled to the frame, wherein the mixing assembly includes a mixer manifold, a first inlet for connection to a source of pressurized air, a second inlet for connection to a source of a first polyurethane foam component, and a third inlet for connection to a source of a second polyurethane foam component.

### CROSS-REFERENCE TO RELATED APPLICATIONS

This application claims priority to U.S. Application No. 63/565,361, filed Mar. 14, 2024, the entire contents of which are incorporated herein by reference.

### FIELD

The present disclosure relates generally to polyurethane injection gun assemblies for injection of polyurethane foam.

### BACKGROUND

Polyurethane injection guns are commonly used to inject polyurethane foam underneath concrete for the purpose of raising the concrete and filling voids in the concrete. The guns typically receive a liquid isocyanate, also referred to as an “A” component, and a liquid blend of polyols, also referred to as a “B” component. These two components are mixed in a mix chamber of the gun to form the polyurethane foam. The polyurethane foam is then purged with pressurized air from a fluid housing of the gun.

### SUMMARY

In accordance with one example, a polyurethane injection gun assembly includes a frame, a handle coupled to the frame, a wheel coupled to the frame, and a mixing assembly coupled to the frame. The mixing assembly includes a mixer manifold, a first inlet for connection to a source of pressurized air, a second inlet for connection to a source of a first polyurethane foam component, and a third inlet for connection to a source of a second polyurethane foam component.

In accordance with another example, a polyurethane injection gun assembly includes a frame, a handle coupled to the frame, a first gear coupled to the handle, and a mixing assembly coupled to the frame. The mixing assembly includes a mixer manifold, a first inlet for connection to a source of pressurized air, a second inlet for connection to a source of a first polyurethane foam component, and a third inlet for connection to a source of a second polyurethane foam component. The polyurethane injection gun assembly further includes a swivel connector coupled to the mixing assembly. The swivel connector includes a second gear that is configured to be rotated via the first gear when the handle is rotated.

In accordance with another example, a polyurethane injection gun assembly includes a frame having a first frame base, a first handle arm extending upwardly from the first frame base, a second frame base, and a second handle arm extending upwardly from the second frame base. The first handle arm is adjustable relative to the first frame base, and the second handle arm is adjustable relative to the second frame base. The polyurethane injection gun assembly also includes wheels coupled to the frame, a handle coupled to the frame, an elongate rod coupled to the handle, a first gear coupled to the rod, and a mixing assembly coupled to the frame. The mixing assembly includes a mixer manifold coupled to the first frame base and the second frame base, a first inlet for connection to a source of pressurized air, a second inlet for connection to a source of a first polyurethane foam component, and a third inlet for connection to a source of a second polyurethane foam component. The polyurethane injection gun assembly also includes a swivel connector coupled to the mixing assembly. The swivel connector includes a second gear that is configured to be rotated via the first gear when the handle is rotated.

Other features and aspects of the disclosure will become apparent by consideration of the following detailed description and accompanying drawings.

### BRIEF DESCRIPTION OF THE DRAWINGS

FIG. 1 is a front perspective view of a polyurethane injection gun assembly according to one example.

FIG. 2 is a rear perspective view of the polyurethane injection gun assembly.

FIG. 3 is a right side view of the polyurethane injection gun assembly.

FIG. 4 is a left side view of the polyurethane injection gun assembly.

FIG. 5 is a partial, enlarged left side view of a portion of the polyurethane injection gun assembly.

FIG. 6 is a bottom perspective view of the polyurethane injection gun assembly.

FIG. 7 is a schematic illustration of a system of more than one polyurethane injection gun assembly.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein is for the purpose of description and should not be regarded as limiting.

### DETAILED DESCRIPTION

A “polyurethane foam” as used herein refers to polymers that contain the molecular structure of urethane —(—NH—CO—O—)—, urea —(—NH—CO—NH—)—, or both. Such polymers are typically obtained by reacting polyisocyanates, also referred to as the “A” component, with isocyanate-reactive compounds such as polyols, also referred to as the “B” component, often using foaming agents. As used herein, the terms “top,” “bottom,” “front,” “rear,” “side,” “upwardly,” “downwardly,” and other directional terms are not intended to require any particular orientation, but are instead used for purposes of description only.

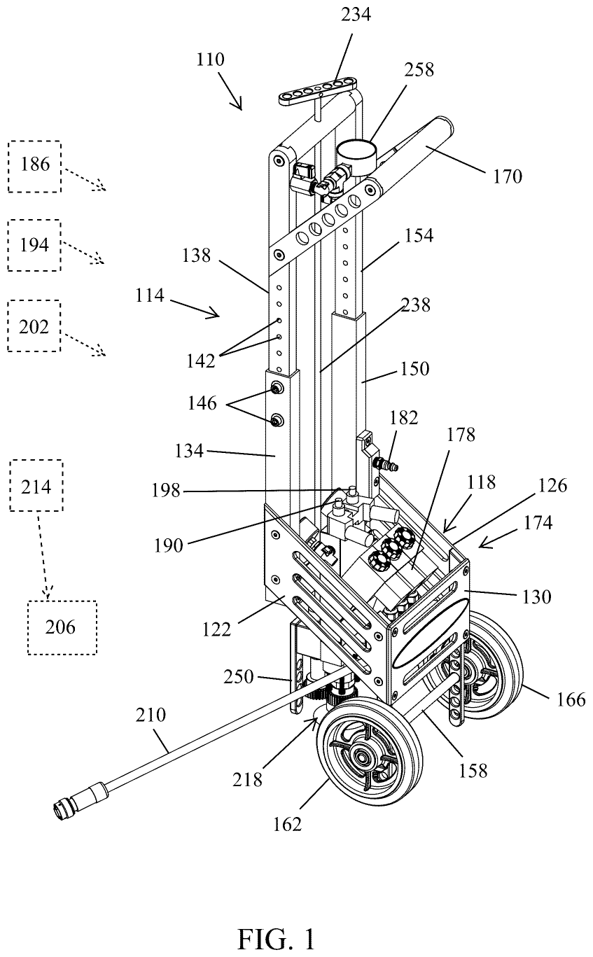

FIGS. 1-6 illustrate a polyurethane injection gun assembly 110. The polyurethane injection gun assembly 110 is movable, and is primarily intended for injecting polyurethane foam to raise or lift concrete or other material, although the polyurethane injection gun assembly 110 may be used for other purposes and/or for injecting other material.

With continued reference to FIGS. 1-6, the polyurethane injection gun assembly 110 includes a frame 114. In the illustrated example, the frame 114 is formed at least partially of metal, although other examples may include different materials. The illustrated frame 114 includes a frame basket 118 (e.g., defining an interior cavity or region to carry and/or contain and/or protect one or more components of the polyurethane injection gun assembly 110). As illustrated in FIG. 1, the frame basket 118 includes a first side wall 122, a second side wall 126 located opposite the first side wall 122, and a front wall 130 that connects the first side wall 122 to the second side wall 126 and extends perpendicular to both the first side wall 122 and the second side wall 126. Other examples of the frame 114 may include other numbers and arrangements of frame baskets 118 and/or walls. In some examples, the frame 114 does not include a frame basket 118.

With reference to FIGS. 1-4, in the illustrated example the frame 114 includes a first frame base 134 coupled (e.g., fixed) to the frame basket 118, and a first handle arm 138 extending upwardly from the first frame base 134. The first handle arm 138 is adjustable (e.g., vertically) relative to the first frame base 134 (e.g., to accommodate for different sized users). As illustrated in FIG. 1, the first handle arm 138 includes apertures 142, and the frame 114 includes one or more fasteners 146 (e.g., bolts) that pass through the first frame base 134 and into the apertures 142 to selectively adjust an overall height of the frame 114.

With continued reference to FIGS. 1-4, the frame 114 further includes a second frame base 150 coupled (e.g., fixed) to the frame basket 118, and a second handle arm 154 extending upwardly from the second frame base 150. The second handle arm 154 may be coupled (e.g., fixed) to the first handle arm 138, such that the first handle arm 138 and the second handle arm 154 move together. Accordingly, the second handle arm 154 may also be adjustable (e.g., vertically) relative to the second frame base 150. Other examples include other numbers and arrangements of frame components, including frame bases and frame arms. In some examples, the height of the frame 114 is not adjustable (e.g., vertically), and is instead fixed.

With reference to FIGS. 1-6, the polyurethane injection gun assembly 110 further includes at least one wheel coupled to the frame 114, such that the polyurethane injection gun assembly 110 may be moved manually and transported from one location to another (e.g., by pushing and/or pulling the polyurethane injection gun assembly 110). In the illustrated example, the polyurethane injection gun assembly includes an axle 158 coupled to the frame 114, a first wheel 162 coupled (e.g., rotationally coupled) to the axle 158, and a second wheel 166 coupled (e.g., rotationally coupled) to the axle 158. Other examples include only a single wheel, or more than two wheels (e.g., three wheels or four wheels).

With reference to FIGS. 1-4, the polyurethane injection gun assembly 110 further includes at least one handle coupled to the frame 114. In the illustrated example, the polyurethane injection gun assembly 110 includes a steering handle 170 coupled (e.g., fixed) to both the first handle arm 138 and the second handle arm 154. As illustrated in FIGS. 1-4, the steering handle 170 extends at an angle (e.g., an oblique angle) relative to each of the first handle arm 138 and the second handle arm 154, and may be gripped for example by an operator to tilt and/or push and/or pull the overall frame 114 and the injection gun assembly 110, thereby moving the overall polyurethane injection gun assembly 110 from one location to another. Other examples include other numbers and arrangements or orientations of a steering handle 170, or do not include a steering handle 170. In some examples, the steering handle 170 is adjustable or movable along the frame 114, to accommodate for different sized users.

With reference to FIGS. 1-6, the polyurethane injection gun assembly 110 further includes a mixing assembly 174 coupled to the frame 114, to mix and/or otherwise form polyurethane foam. In the illustrated example, the mixing assembly 174 includes a mixer manifold 178, a first inlet 182 (FIG. 1) for connection to a source 186 (illustrated schematically) of pressurized air, a second inlet 190 (FIG. 1) for connection to a source 194 (illustrated schematically) of a first polyurethane foam component (e.g., an “A” component), and a third inlet 198 (FIG. 1) for connection to a source 202 (illustrated schematically) of a second polyurethane foam component (e.g., a “B” component). As illustrated in FIG. 1, at least a portion or portions of the mixing assembly 174 may be positioned and/or contained within the frame basket 118, such that the mixing assembly 174 is at least partially enclosed and protected.

With continued reference to FIG. 1, in the illustrated example the first inlet 182 is located on the frame 114 (e.g., on the second frame base 150), such that pressurized air is directed into at least a portion of the frame 114. Accordingly, the frame 114 itself may act as a chamber and/or guide for storing and/or moving pressurized air. The air may be directed (e.g., via the frame 114 and/or hoses, connections, etc.) from the first inlet 182 to the mixer manifold 178. Other examples include other locations for the first inlet 182 (e.g., on the mixer manifold 178).

In the illustrated example, the second inlet 190 and the third inlet 198 are each located on the mixer manifold 178, although in other examples the second inlet 190 and the third inlet 198 may be located in other locations than that illustrated.

With continued reference to FIG. 1, the mixer manifold 178 includes a set of valves 206 (e.g., open/close valves, illustrated schematically and offset from the manifold 178 in FIG. 1 for illustrative purposes only) to control a flow of the pressurized air, the first polyurethane foam component, and/or the second polyurethane foam component through the mixer manifold 178. In the illustrated example, the polyurethane injection gun assembly 110 additionally includes an electrical inlet line 210 that is coupled to the mixer manifold 178 (and for example to the valves 206), for example to provide electrical power to the valves 206. In some examples, the polyurethane injection gun assembly 110 further includes one or more remotes 214 (illustrated schematically) to control opening and closing of each of the valves in the set of valves 206. Accordingly, in some examples, a user may be positioned away from the frame 114 and the mixing assembly 174, and may operate and control the mixing assembly 174 remotely via the remote 214. In some examples, the remote 214 is a wireless remote, that wirelessly sends signals to the valves 206 to open and/or close.

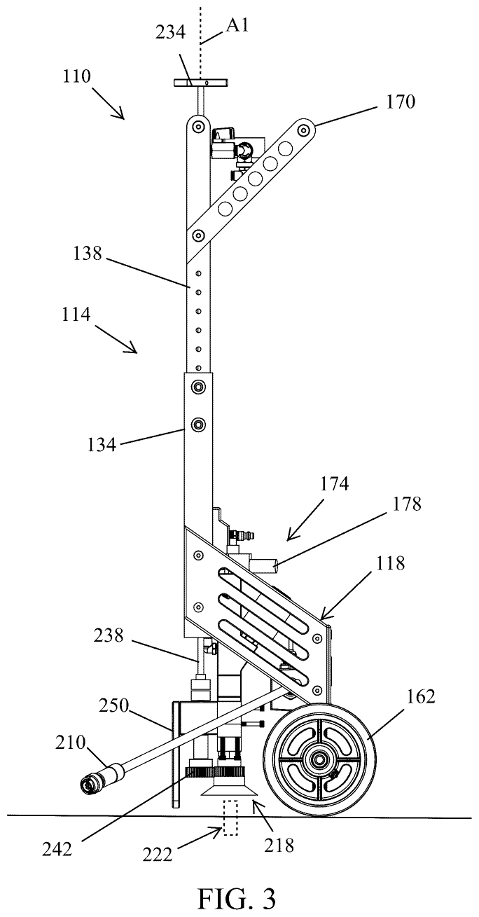

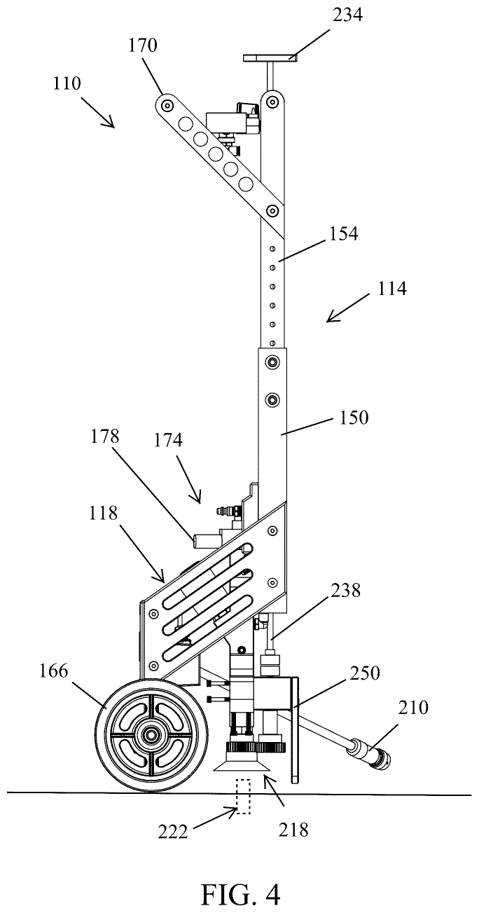

With reference to FIGS. 1-6, the polyurethane injection gun assembly 110 further includes a swivel connector 218 coupled to the mixing assembly 174 (e.g., to a lower end of the mixer manifold 178). The swivel connector 218 may be sized and shaped, for example, to engage and releasably couple to a port 222 (e.g., a twist lock port, illustrated schematically in FIGS. 3 and 4) that is positioned in concrete (or other material), such that when the swivel connector 218 is coupled to the port 222, the polyurethane foam may be directed out of the mixing assembly 174 and through the port 222 (e.g., to a location beneath the concrete to thereby lift the concrete).

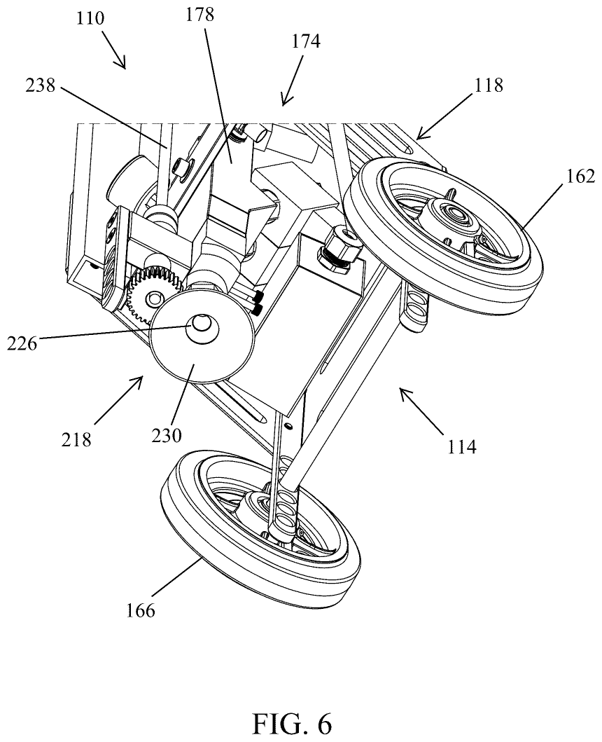

In the illustrated example, and with reference to FIG. 6, the swivel connector 218 includes an opening 226 sized and shaped to receive the port 222 (e.g., an upper end of the port 222), and a splash guard 230 that is sized and shaped to help guide the polyurethane injection gun assembly 110 down onto the port 222 and/or inhibit splashing of the polyurethane foam that exits out of the swivel connector 218 and into the port 222. In the illustrated example, the splash guard 230 is shaped as a shield, and has a generally conical shape. Other examples include other shapes and sizes. In some examples, a splash guard 230 is not provided.

With reference to FIGS. 1-6, the polyurethane injection gun assembly 110 includes at least one component that facilitates coupling and de-coupling of the swivel connector 218 to the port 222. In the illustrated example, the polyurethane injection gun assembly 110 includes a T-shaped handle 234. While the illustrated handle 234 is T-shaped, other examples may include other shapes.

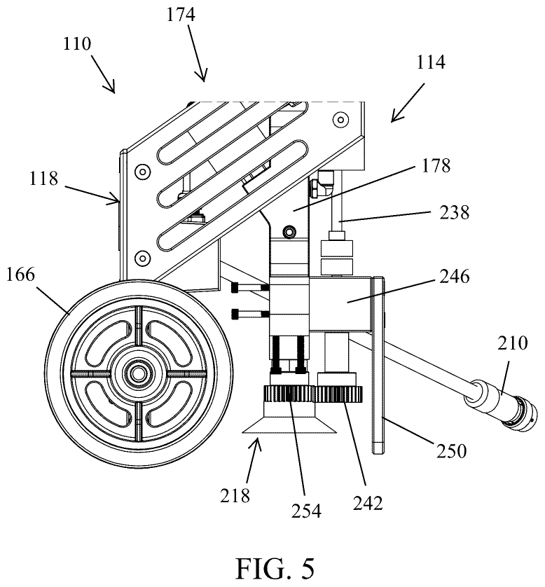

With continued reference to FIGS. 1-6, the polyurethane injection gun assembly 110 further includes an elongate rod 238 that extends (e.g., vertically down) from the T-shaped handle 234 along a longitudinal axis A1 (FIG. 3), and a first gear 242 that is coupled to the elongate rod 238 (e.g., at a distal end of the elongate rod 238). As illustrated in FIG. 5, the elongate rod 238 extends through a rear support block 246 that is coupled (e.g., fixed to the mixer manifold 178), such that the elongate rod 238 is generally fixed translationally, and is only permitted to rotate about the longitudinal axis A1. In other examples the elongate rod 238 may pass through one or more different portions of the frame and/or may not pass through a rear support block 246.

With continued reference to FIG. 5, the polyurethane injection gun assembly 110 additionally includes a rear leg support 250 coupled (e.g., fixed) to the rear support block 246. The rear leg support 250 may be used, for example, as a support point and may contact a ground surface (e.g., concrete) when the polyurethane injection gun assembly 110 is being used to deliver the polyurethane foam into the port 222. Other examples do not include the rear leg support 250, or include more than one rear leg support 250, or include other locations for a rear leg support 250 than that illustrated.

With continued reference to FIG. 5, the swivel connector 218 further includes a second gear 254 (e.g., a ring gear) that is sized and shaped to be rotated via the first gear 242 when the T-shaped handle 234 is rotated about the longitudinal axis A1.

In some examples, the port 222 includes a set of threads (e.g., external threads) at a top of the port 222, and the swivel connector 218 includes a set of corresponding threads (e.g., internal threads) located along a bottom of the swivel connector 218 (e.g., in the opening 226). Accordingly, when the second gear 254 is rotated via the first gear 242, the internal threads of the swivel connector 218 engage with the external threads of the port 222, to thereby temporarily lock the swivel connector 218 to the port 222.

When the polyurethane injection gun assembly 110 is no longer being used with the port 222, the T-shaped handle 234 (and its connected first gear 242) may be rotated in the opposite direction, to thereby rotate the second gear 254 and unthread (or otherwise de-couple) the swivel connector 218 from the port 222. In some examples, the connection between the swivel connector 218 and the port 222 may additionally, or alternatively, include other types of temporary connections than threaded connections (e.g., bayonet connections, snap-fit connections, friction-fit connections, etc.).

The polyurethane injection gun assembly 110 may advantageously allow the user to stand (rather than being on knees on the ground). For example, and as described above, the user may simply stand and rotate the T-shaped handle 234 to couple and de-couple the swivel connector 218 to and from the port 222.

Additionally, and as described above, the wireless remote 214 may be used to control the flow of foam and/or air components through the polyurethane injection gun assembly 110. Accordingly, the wireless remote 214 may activate the valves 206, causing them to open and close by a push of a button. This may eliminate any need for the user to get down on the concrete (e.g., on his or her knees). In some examples, the user may be able to walk away from the polyurethane injection gun assembly 110 and visually inspect a slab of concrete (or other material), while the polyurethane injection gun assembly 110 is operating (e.g., delivering foam through the port 222).

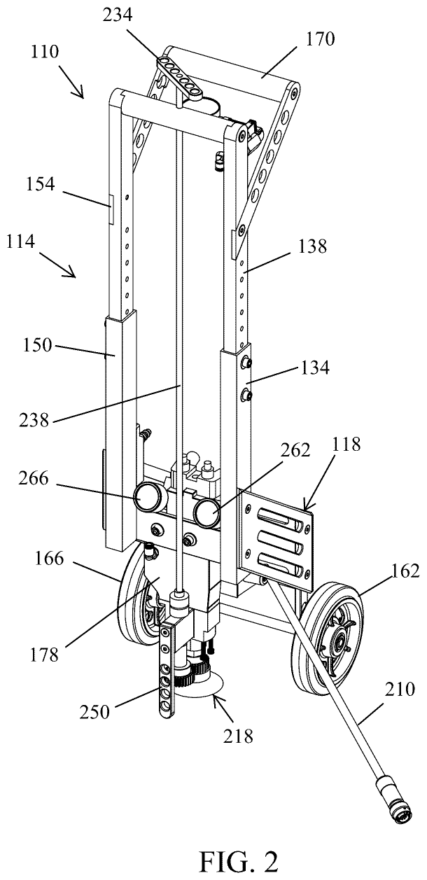

With reference to FIGS. 1-6, in some examples the polyurethane injection gun assembly 110 additionally includes one or more gauges to display pressure or other information. In the illustrated example, the polyurethane injection gun assembly 110 includes a first gauge 258 (FIG. 1) for displaying air pressure, a second gauge 262 (FIG. 2) for displaying fluid pressure within the mixer manifold 178 (e.g., a pressure of the “A” component), and a third gauge 266 (FIG. 2) for displaying fluid pressure within the mixer manifold 178 (e.g., a pressure of the “B” component). Other examples include other numbers and arrangements of gauges. In some examples, no gauges are provided.

While a particular swivel connector 218, a particular port 222, and a particular mixing assembly 174 are illustrated and described, other examples of a swivel connector, a port, a mixing assembly, and/or other components of a polyurethane injection gun assembly may be found for example in WO2018/027047A1, the entire contents of which are incorporated herein by reference. Accordingly, in some examples any of the components described in WO2018/027047A1 may be used in combination with (or as replacements for) any of the features and components described herein.

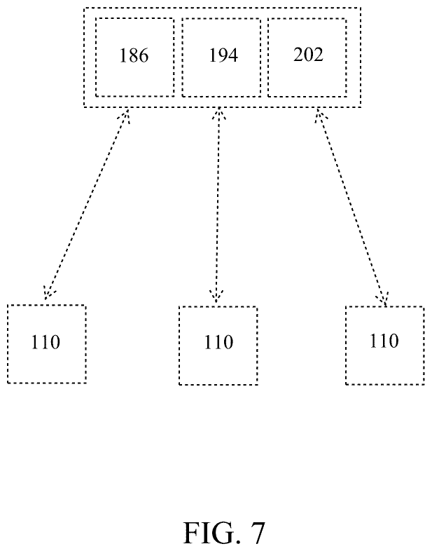

With reference to FIG. 7, in some examples a system of two or more polyurethane injection gun assemblies 110 (e.g., three polyurethane injection gun assemblies 110 as illustrated in FIG. 7) may be connected at the same time to the source 186 of pressurized air, the source 194 of the first polyurethane foam component, and/or the source 202 of the second polyurethane component, such that polyurethane may be injected through the injection gun assemblies 110 one at a time, or simultaneously. This may eliminate a need for multiple polyurethane trucks, and/or may be facilitate a smoother or more uniform lift of the concrete (or other material). In some examples, the remote 214 (or another remote or remotes) may be used to control flow of air, the “A” component, and/or the “B” component to each of the polyurethane injection gun assemblies 110, and/or may be used to control the opening and closing of the valves 206 in one or more of the polyurethane injection gun assemblies 110.

With reference to FIGS. 1-6, during use of the polyurethane injection gun assembly 110, the user may first grasp the steering handle 170 and wheel the polyurethane injection gun assembly 110 (via the first wheel 162 and the second wheel 166) to the location of the port 222 that is inserted in the concrete slab (or other material). During this wheeled movement, the user may tilt the frame 114 away from a vertical orientation. Once at the location of the port 222, the frame 114 may be tilted back toward the vertical orientation, and the user may generally align the splash guard 230 of the swivel connector 218 over the upper end of the port 222, until the opening 226 receives the upper end of the port 222. In this position the rear leg support 250 may be engaged with the ground (e.g., with the concrete slab).

The user may then rotate the T-shaped handle 234, causing the first gear 242 to rotate the second gear 254, and thereby temporarily lock the swivel connector 218 to the port 222.

Once the swivel connector 218 is locked to the port 222, the user may then use the wireless remote 214 (or any manual controls located for example on the frame 114, the mixing assembly 174, or other location on the polyurethane injection gun assembly 110) to control operation of the mixing assembly 174. Accordingly, the user may control mixing of the “A” and “B” components in the mixing assembly 174 to create polyurethane foam, and may control the pressurized air to purge the polyurethane foam and push the polyurethane foam out of the mixing assembly 174 and through both the swivel connector 218 and the attached port 222 (e.g., into a space or gap below port 222 and/or below the concrete slab).

Once the polyurethane foam has been delivered, the user may then disconnect the swivel connector 218 from the port 222 by rotating the T-shaped handle 234 in an opposite rotational direction. The user may then again tilt the frame 114, and may wheel the overall polyurethane injection gun assembly 110 to a different port 222 or to a different general location.

Although the disclosure has been described in detail with reference to certain preferred embodiments, variations and modifications exist within the scope and spirit of one or more independent aspects of the disclosure as described.

What is claimed is:

1. A polyurethane injection gun assembly comprising:
a frame;
a handle coupled to the frame;
a wheel coupled to the frame; and
a mixing assembly coupled to the frame, wherein the mixing assembly includes a mixer manifold, a first inlet for connection to a source of pressurized air, a second inlet for connection to a source of a first polyurethane foam component, and a third inlet for connection to a source of a second polyurethane foam component.

2. The polyurethane injection gun assembly of claim 1, wherein the handle is configured to be rotated about a longitudinal axis, wherein the handle is coupled to a gear.

3. The polyurethane injection gun assembly of claim 2, wherein the gear is a first gear, wherein the polyurethane injection gun assembly further includes a swivel connector coupled to the mixing assembly, wherein the swivel connector includes a second gear that is configured to be rotated via the first gear when the handle is rotated about the longitudinal axis.

4. The polyurethane injection gun assembly of claim 3, further comprising an elongate rod extending between the handle and the first gear.

5. The polyurethane injection gun assembly of claim 4, further comprising a rear support block fixed to the mixer manifold and a rear leg support fixed to the rear support block, wherein the elongate rod passes through the rear support block.

6. The polyurethane injection gun assembly of claim 3, wherein the swivel connector includes an opening sized and shaped to receive a twist lock port, and a splash guard configured to guide the polyurethane injection gun assembly onto the twist lock port.

7. The polyurethane injection gun assembly of claim 3, further comprising a twist lock port having a gear, wherein the twist lock port is configured to be inserted into concrete, and wherein the polyurethane injection gun assembly is configured to fasten itself to the twist lock port via rotation of the handle about the longitudinal axis.

8. The polyurethane injection gun assembly of claim 1, wherein the mixer manifold includes a set of valves to control a flow of the pressurized air, the first polyurethane foam component, and the second polyurethane foam component, wherein the polyurethane injection gun assembly further includes a wireless remote to control opening and closing of valves in the set of valves.

9. The polyurethane injection gun assembly of claim 1, wherein the first inlet is located on the frame.

10. The polyurethane injection gun assembly of claim 9, wherein the second inlet is located on the mixer manifold and the third inlet is located on the mixer manifold.

11. A system comprising:
a plurality of the polyurethane injection gun assemblies of claim 1, wherein each of the polyurethane injection gun assemblies is coupled to the source of pressurized air, the source of the first polyurethane foam component, and the source of the second polyurethane foam component.

12. The polyurethane injection gun assembly of claim 1, wherein the handle is a first handle, wherein the polyurethane injection gun assembly includes a second, steering handle coupled to the frame, wherein the steering handle is fixed relative to the frame.

13. The polyurethane injection gun assembly of claim 1, wherein the frame includes a first frame base, a first handle arm extending upwardly from the first frame base, a second frame base, and a second handle arm extending upwardly from the second frame base, wherein the first handle arm is adjustable relative to the first frame base, and wherein the second handle arm is adjustable relative to the second frame base.

14. A polyurethane injection gun assembly comprising:
a frame;
a handle coupled to the frame;
a first gear coupled to the handle;
a mixing assembly coupled to the frame, wherein the mixing assembly includes a mixer manifold, a first inlet for connection to a source of pressurized air, a second inlet for connection to a source of a first polyurethane foam component, and a third inlet for connection to a source of a second polyurethane foam component; and
a swivel connector coupled to the mixing assembly, wherein the swivel connector includes a second gear that is configured to be rotated via the first gear when the handle is rotated.

15. The polyurethane injection gun assembly of claim 14, further comprising an elongate rod extending between the handle and the first gear.

16. The polyurethane injection gun assembly of claim 15, further comprising a rear support block fixed to the mixer manifold and a rear leg support fixed to the rear support block, wherein the elongate rod passes through the rear support block.

17. The polyurethane injection gun assembly of claim 14, wherein the swivel connector includes an opening sized and shaped to receive a twist lock port, and a splash guard configured to guide the polyurethane injection gun assembly onto the twist lock port.

18. The polyurethane injection gun assembly of claim 14, wherein the mixer manifold includes a set of valves to control a flow of the pressurized air, the first polyurethane foam component, and the second polyurethane foam component, wherein the polyurethane injection gun assembly further includes a wireless remote to control opening and closing of valves in the set of valves.

19. A system comprising:
a plurality of the polyurethane injection gun assemblies of claim 14, wherein each of the polyurethane injection gun assemblies is coupled to the source of pressurized air, the source of the first polyurethane foam component, and the source of the second polyurethane foam component.

20. A polyurethane injection gun assembly comprising:
a frame having a first frame base, a first handle arm extending upwardly from the first frame base, a second frame base, and a second handle arm extending upwardly from the second frame base, wherein the first handle arm is adjustable relative to the first frame base, and wherein the second handle arm is adjustable relative to the second frame base;
wheels coupled to the frame;
a handle coupled to the frame;
an elongate rod coupled to the handle;
a first gear coupled to the elongate rod;
a mixing assembly coupled to the frame, wherein the mixing assembly includes a mixer manifold coupled to the first frame base and the second frame base, a first inlet for connection to a source of pressurized air, a second inlet for connection to a source of a first polyurethane foam component, and a third inlet for connection to a source of a second polyurethane foam component; and
a swivel connector coupled to the mixing assembly, wherein the swivel connector includes a second gear that is configured to be rotated via the first gear when the handle is rotated.
